(19) United States
(12) Patent Application Publication
(10) Pub. No.: US 2018/0088914 A1
(43) Pub. Date: Mar. 29, 2018

(54) METHOD FOR SUPPORTING PROGRAM CREATION AND APPARATUS FOR SUPPORTING PROGRAM CREATION

(71) Applicant: HONDA MOTOR CO., LTD., Tokyo (JP)

(72) Inventors: Shogo Sawasaki, Tochigi (JP); Naoki Kobayashi, Tochigi (JP)

(21) Appl. No.: 15/715,457

(22) Filed: Sep. 26, 2017

(30) Foreign Application Priority Data
Sep. 28, 2016 (JP) 2016-190452

(51) Int. Cl. G06F 9/44

(52) U.S. Cl. CPC G06F 8/36; G06F 8/34

(57) ABSTRACT

Provided is a method that can support creation of a program while facilitating reduction in cost even if the program is a complicated one. Unnecessary factors are removed from each of the codes included in information software (21), and basic codes are created. Pieces of designation information pertaining to respective capabilities are extracted from basic codes according to a predetermined extraction rule. The extracted designation information can be used to allow the user to select indirectly or directly the capability or processing details contained in the new test software (222) to be generated. A user is allowed to create a flowchart that includes components defined by the selection, and the functions associated with each component included in the flowchart are entered in a template (predetermined pattern), thereby automatically generating a new code describing the new test software (222).

### BACKGROUND OF THE INVENTION

### Field of the Invention

The present invention relates to a method and apparatus for supporting program creation.

### Description of the Related Art

Test programs for multiple ECUs mounted on a vehicle using a vehicle test apparatus are typically created by experts or programmers having excellent skill and rich knowledge and experience. Conventionally, there has been proposed methods for automatically generating a program having relatively simple common specifications by automatically reading the types and connection relationships of blocks from diagram data on program flowcharts, automatically determining the arrangement orders of the blocks, and converting the blocks into corresponding instruction statements (e.g., Japanese Patent Laid-Open Nos. 2000-242479, 2000-339150 and H11-353169, International Publication No. WO 2007/037310, and Japanese Patent Laid-Open Nos. H06-318151, 6-214777 and H09-198236).

However, for example, a complicated test program for a new model vehicle is still created only as a standalone program supportable only for limited models and ECUs, and requires creation cost.

To address this, the present invention has an object to provide a method capable of supporting creation of a program while facilitating reduction in cost even for a complicated program.

### SUMMARY OF THE INVENTION

A method for supporting program creation according to the present invention includes: a first process of removing unnecessary factors from a plurality of codes that describe a plurality of capabilities included in a compilable existing program to create a plurality of basic codes, and extracting a plurality of designation informations associated with the respective capabilities from among each of the basic codes according to a predetermined extraction rule; a second process of selecting at least one symbol among a plurality of symbols and selecting at least one designation information from among the plurality of designation informations to create a new flowchart that includes at least two components among a plurality of components that are defined by the symbols and capabilities and are associated with respective functions, the at least two components being defined by the selected symbol and the capability associated with the selected designation information; and a third process of entering, in a predetermined pattern, at least two functions associated with the at least two components among the functions to generate a new code describing a new program.

The method for supporting program creation of the present invention removes unnecessary factors from the codes contained in the existing program, and the basic codes are created. Consequently, situations where unnecessary factors inhibit to apply the predetermined extraction rule are prevented, and the pieces of designation information pertaining to the respective capabilities are securely extracted from each of the basic codes according to the predetermined extraction rule. As the existing program can be compiled, the designation information pertaining to a meaningless code that cannot be executed is prevented from being extracted.

The extracted designation information can be used to allow the user to select indirectly or directly the capability or processing details contained in the newly created program. That is, selection of the capability through selection of the symbol and selection of the designation information enables the user to create the flowchart made up of components defined by the selected symbol and the selected capability. Consequently, the user's erroneous input and erroneous description during flowchart creation are securely avoided, and improvement in flowchart creation accuracy is facilitated.

The functions associated with the respective components included in the created flowchart are entered in the predetermined pattern, thereby automatically creating a new code describing a new program.

Accordingly, even if the user's program creation skill is not much high, a program having high quality in conformity with the specifications is generated only with user's knowledge of the program specifications to a certain extent. Consequently, reduction in the cost of creating the program is facilitated.

### BRIEF DESCRIPTION OF THE DRAWINGS

FIG. 1 is an illustrative diagram pertaining to a configuration of a vehicle test apparatus that stores LET software;

FIG. 2 is an illustrative diagram pertaining to a configuration of test software;

FIG. 3 is an illustrative diagram pertaining to a method for supporting program creation as an embodiment of the present invention;

FIG. 4A is an illustrative diagram pertaining to a first example of basic code creation and designation information extraction;

FIG. 4B is an illustrative diagram pertaining to a second example of the basic code creation and designation information extraction;

FIG. 5 is a diagram exemplifying an interface for supporting flowchart creation;

FIG. 6A is a diagram exemplifying functionalization of a flowchart diagram;

FIG. 6B is a diagram exemplifying a template (pattern) of a new program code;

FIG. 7A is a diagram exemplifying results of assigning function names and results of extracting arguments based on a created flowchart;

FIG. 7B is a diagram exemplifying sequential number functions;

FIG. 7C is a diagram exemplifying the new program code;

FIG. 8A is a first diagram exemplifying a selection route of the flowchart; and

FIG. 8B is a second diagram exemplifying a selection route of the flowchart.

### DETAILED DESCRIPTION OF THE PREFERRED EMBODIMENTS

(Configuration of Vehicle Test Apparatus)

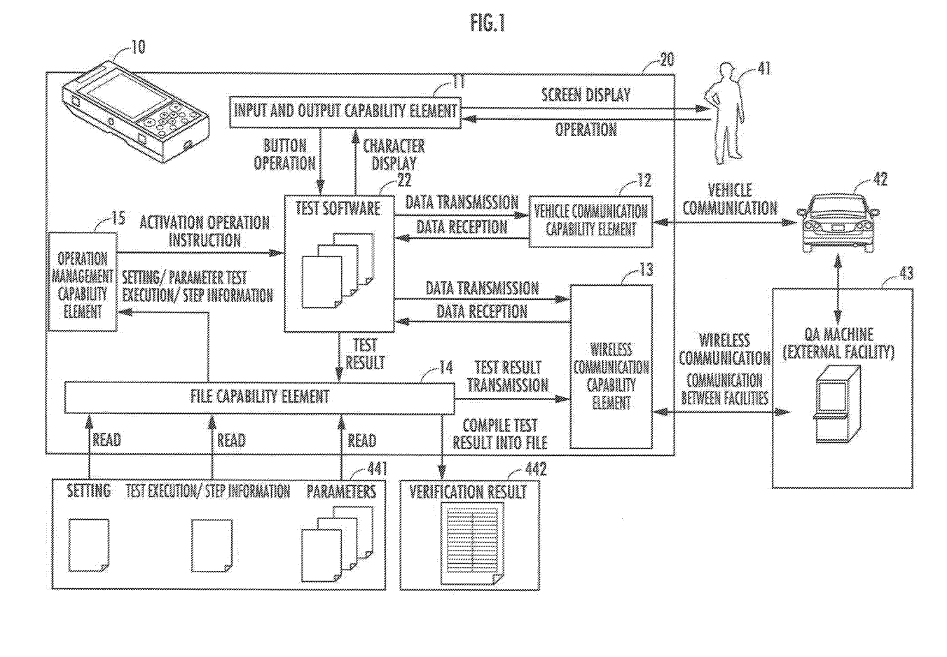

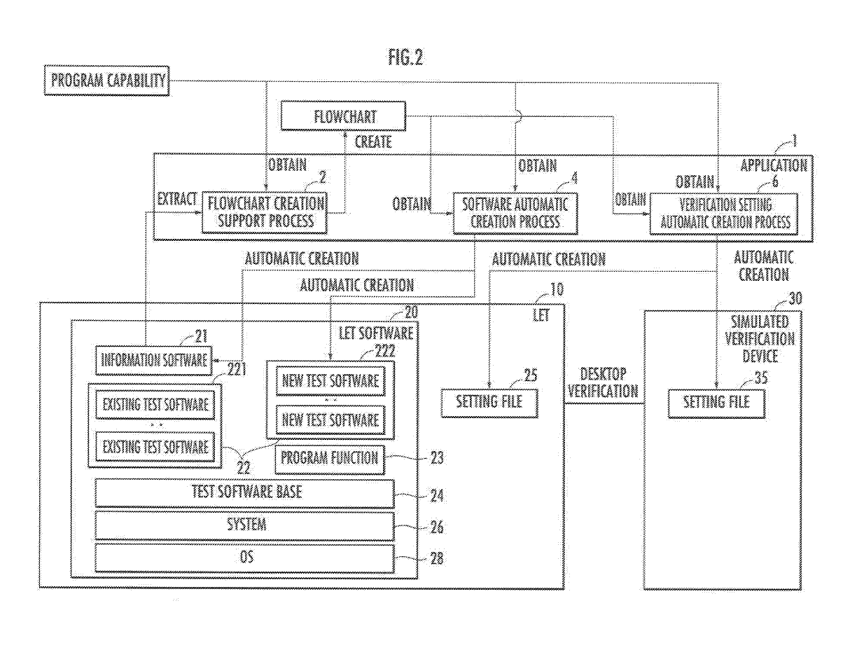

A method for supporting program creation that is an embodiment of the present invention is described. A program that is a generation target in this embodiment is a part of LET software 20 (new test software 222 (see FIG. 2)) used in a vehicle test apparatus 10 (hereinafter, appropriately called LET (Line End tester)) for diagnosing various functions of a vehicle 42 shown in FIG. 1. The vehicle test apparatus 10 includes capability elements that are an input and output capability element 11, a vehicle communication capability element 12, a wireless communication capability element 13, a file capability element 14, and an operation management capability element 15. Each capability element includes LET software 20 (software), and a processor or processor core (hardware) that executes arithmetic processes according to the LET software 20.

The input and output capability element 11 provides an output interface for outputting information, such as information required to test the various functions of the vehicle 42 and a test result, to a test operator 41 through a display (a component of the vehicle test apparatus 10), and an input interface for allowing the test operator 41 to input operations and instructions for the test through buttons (components of the vehicle test apparatus 10).

The vehicle communication capability element 12 executes data communication with the vehicle 42 that is a test target, for example, multiple ECUs (electronic control units) mounted on the vehicle 42, in a wired manner.

The wireless communication capability element 13 wirelessly executes data communication with an external apparatus 43. The external apparatus 43 includes a QA machine that is installed in a test facility of the vehicle 42 and is for communicating test data obtained by the facility with the vehicle 42.

The file capability element 14 reads an input file 441 that represents information, such as setting, test execution/step information, and parameter and creates an output file 442 that represents the test result.

The operation management capability element 15 outputs activation and operation instructions to the test software 22 on the basis of the information read by the file capability element 14.

(Configuration of Application Software for Supporting Program Creation)

As shown in FIG. 2, the application software 1 that executes the method for supporting program creation of the present invention is application software that is installed in a computer, thereby obtaining program capabilities (data for defining a format of a flowchart and being associated with a program function 23) and providing the computer with functions of executing a flowchart creation support process 2, a software automatic creation process 4, and a verification setting automatic creation process 6.

The LET software 20 that realizes the various functions of the vehicle test apparatus 10 includes information software 21, pieces of existing test software 221 (existing programs), pieces of new test software 222 (new programs), a program function 23, a test software base 24, a setting file 25, a system 26, and an OS 28 (Operating System). The existing test software 221 and the new test software 222 are called “test software 22” appropriately comprehensively or without discrimination.

In the information software 21, designation information or general information that is common in the test software 22 is defined. The information software 21 communicates with each ECU mounted on the vehicle 42, and executes determination according to a response result from the ECU. ECU information or the like on the vehicle 42 is commonly used in the test software 22. Consequently, the information is in independent files. The information software 21 is processed integrally with each of the pieces of the test software 22, and integrates information for operation of each of the pieces of test software 22. “LET information” defines not only global variables used for integral operation with the pieces of test software 22 but also global variables representing the situations of the vehicle 42 commonly used for the pieces of test software 22 (the number of engine revolutions and engine coolant temperature). “Vehicle information” defines parameters (address, the number of retries, time-out period, etc.) required for communication by the test software 22 with each ECU of the vehicle 42, and command information (command data, command size, etc.). Likewise, according to “facility information”, parameters and command information required for communication with each facility or the external apparatus 43 are defined in the test software 22.

The test software 22 is created by inherited from the test software base 24. The test software 22 passes information on the information software 21 to the function of the test software base 24, and executes processes, thereby executing various tests.

In the test software base 24, processes common to the pieces of test software 22 are functionalized.

The setting file 25 is automatically set by the verification setting automatic creation process 6 of the application software 1. Setting file 35 corresponding to the setting file 25 is automatically set by the verification setting automatic creation process 6 of the application software 1, and is provided for a simulated verification device 30.

The system 26 executes control for image output to the display of the vehicle test apparatus 10 and communication with the vehicle 42.

(Capabilities)

The capabilities of the application software 1 are described. These capabilities are executed by the processor (single core processor, multi-core processor, etc.) included in the computer in which the application software 1 is installed; the processor reads required data and software from the inside of the processor or an external memory, and performs an operation process for the data according to the software. Capability elements for executing a first process, a second process and a third process correspond to a first process element, a second process element and a third process element, respectively. Each element is achieved by the processor.

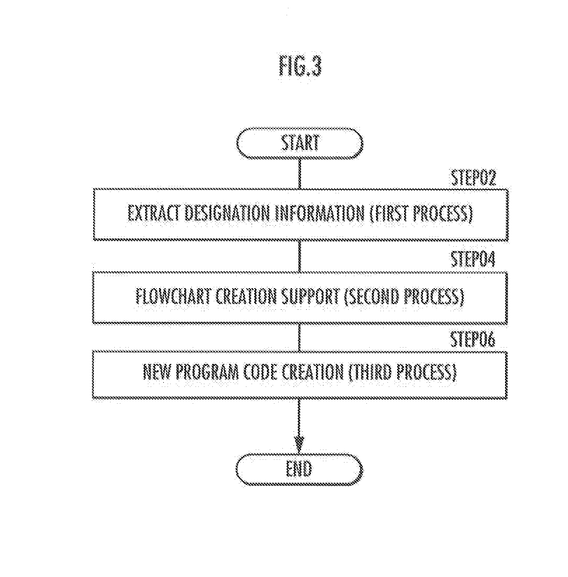

The “FIRST PROCESS” is executed by the flowchart creation support process 2 of the application software 1 (FIG. 3/STEP 02). In particular, unnecessary factors are removed from codes that describe multiple capabilities included in the information software 21, thereby creating basic codes. The pieces of designation information associated with the respective capabilities are extracted from the basic codes according to a predetermined extraction rule. The extracted designation information is held by the flowchart creation support process 2.

The removal of the unnecessary factors means resolving the difference in ways of code writing by programmers, and is a process for constructing an algorithm in consideration of the difference. More specifically, “blanks” are required to be discriminated whether to be blanks required in a source code or unnecessary blanks for improvement in readability. “Line breaks” are required to be discriminated whether to be for a statement sequentially subsequent to the last line or a statement independent of the last line. The values of “variable” and “constant” are required to be predicted from a code. “Comments” irrespective of the program operation are required to be removed.

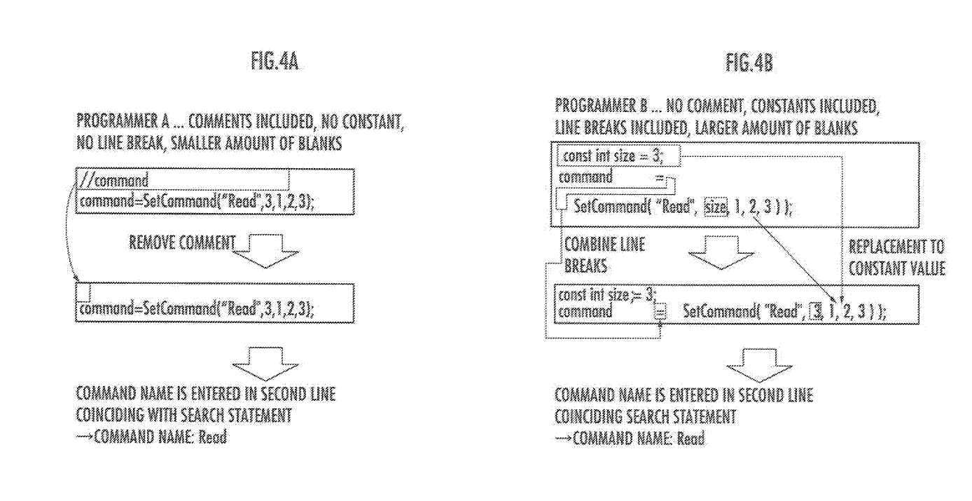

For example, a comment on the first line “//command” is removed from the code shown on the upper side of FIG. 4A, thereby creating a basic code made up of a code on the second line shown on the lower side of FIG. 4A “command=SetCommand(“Read.”,3,1,2,3);”. A command name “Read” is then extracted as designation information from the basic code, and is held by the flowchart creation support process 2.

Referring to the code shown on the upper side of FIG. 4B, the codes on the second and third lines constitute a single statement. Consequently, line breaks on the second and third lines are removed from the code. According to the code on the first line “const int size=3;”, the portion “size” in the code on the third line “SetCommand(“Read”, size 1, 2, 3));” is converted into a constant value “3”. Thus, the basic code shown on the lower side of FIG. 4B is created. On the basis of the basic code, from the code on the third line“SetCommand(“Read”, size, 1, 2, 3));” in the original code, a command name “Read” is extracted as designation information, and is held by the flowchart creation support process 2.

The “SECOND PROCESS” is executed by the flowchart creation support process 2 of the application software 1 (FIG. 3/STEP 04). In particular, multiple symbols are provided through the output interface, thereby allowing a user to select any symbol from among the symbols through the input interface. Likewise, pieces of designation information are provided through the output interface (held by the flowchart creation support process 2), thereby allowing the user to select any piece of designation information from among the pieces of designation information through the input interface. A flowchart is created that is defined to include components defined by symbol selection and by indirect selection of the capability according to selection of the designation information.

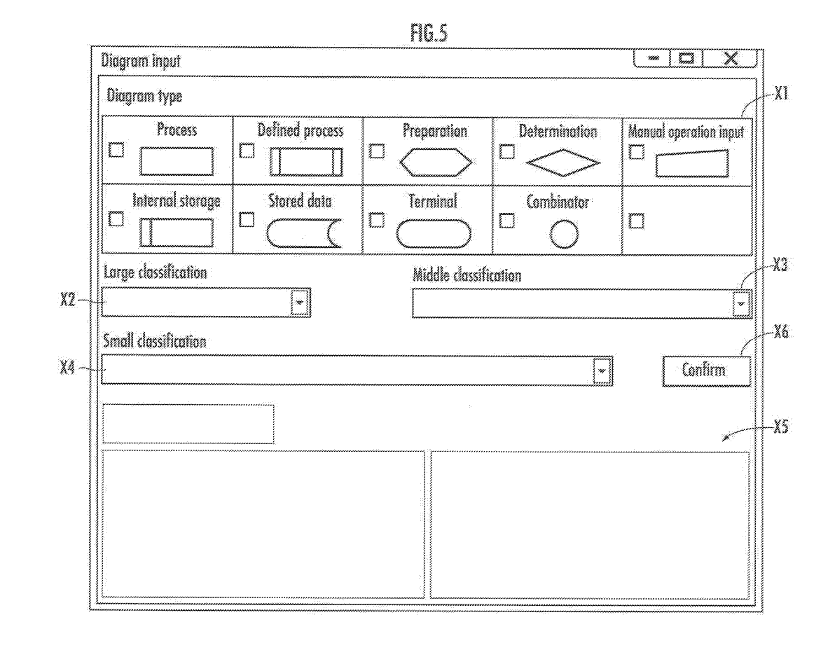

For example, on the display (constituting the output interface) of the computer or an information terminal in which the application software 1 is installed, a screen for supporting flowchart creation shown in FIG. 5 is displayed. On the screen, not only symbol selection fields X1, but also a large classification selection field X2, a middle classification selection field X3 and a small classification selection field X4 for capability or processing details, designation information selection field X5, and a confirmation button X6 are displayed. In the symbol selection fields X1, multiple symbols according to capability types, such as a process, defined process, preparation, determination, manual operation input, internal storage, stored data, terminal, and combinator, are displayed. One symbol is selected from among the symbol selection fields X1 through the input interface, such as a touch panel button. Subsequently, from a pull-down menu displayed at the selection fields X2 to X5, the large classification, the middle classification and the small classification, and the designation information are sequentially selected. An operation on the confirmation button X6 then selects a component defined by the selected symbol, and the capability determined by a combination of the selected large classification, middle classification, small classification, and designation information.

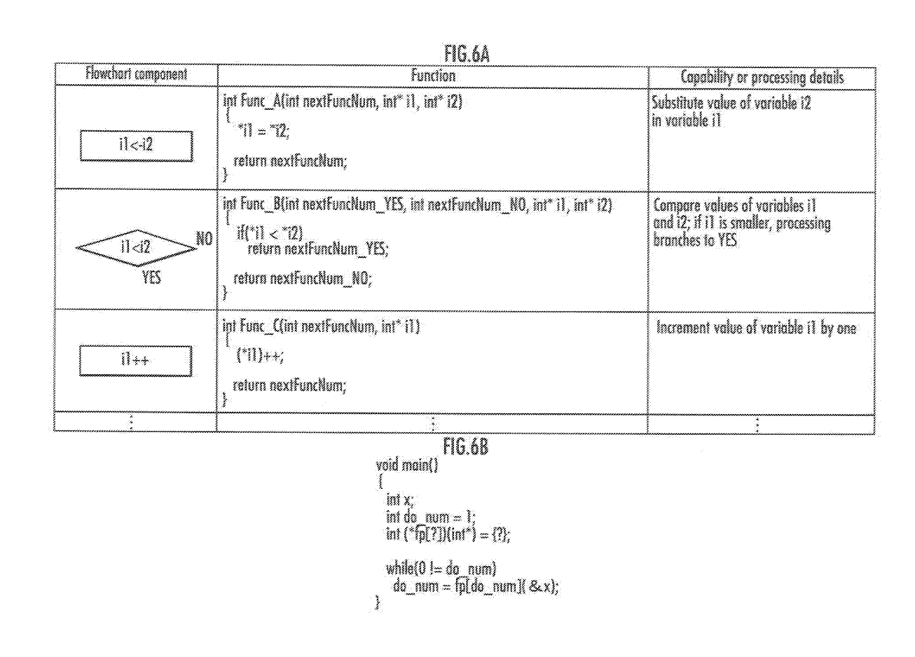

The multiple components (e.g., 500 or more components) that are defined by the symbols and capabilities of the flowchart extracted from the existing test software 221 and the flowchart, and represent the respective capabilities are preliminarily functionalized, associated with the components and functions, and stored in the program function 23. For example, the components indicated in left fields on the lines in FIG. 6A defined by the capabilities indicated by right fields on the lines are preliminarily assigned functions indicated in middle fields on the lines. A template or pattern of the new test software 222 is stored in the program function 23. For example, a template as shown in FIG. 6B is prepared. “{?}” is prepared for an array of function pointers.

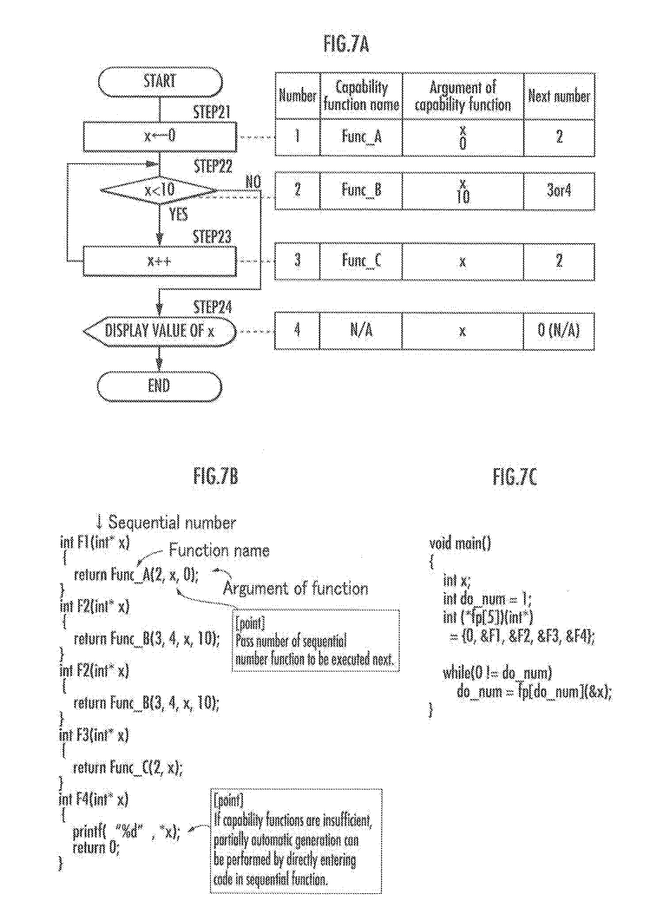

Multiple repetition of the operation of selecting the component as described above creates a flowchart including components STEP 21 to STEP 24 shown on the left side of FIG. 7A, for example.

The “THIRD PROCESS” is then executed by the software automatic creation process 4 of the application software 1 (FIG. 3/STEP 06). More specifically, functions associated with the respective components included in the newly created flowchart among the functions are entered in the template (predetermined pattern), thereby creating a new code describing a new program.

The multiple components included in the flowchart are assigned numbers (sequential numbers), and function names are determined from the symbols and capabilities of the components, and arguments thereof are extracted. STEP 21 to STEP 24 included in the flowchart shown on the left side of FIG. 7A are assigned numbers 1 to 4 indicated on the left fields of tables on the tight side of FIG. 7A (and subsequent numbers indicated in the right fields of the table), the function names indicated in the left middle fields of the tables are determined, and the arguments indicated in the right middle fields of the tables are extracted.

On the basis of the number assigned the function name and the argument, the function of the number is automatically generated. The functions shown in FIG. 7B are thus generated. A portion “•” of a statement “int F•(int*x)” corresponds to the number. A portion “Func_A” of a statement “return Func_A(2, x, 0);” corresponds to the function name. “2” corresponds to the number of a function to be executed next. “x” and “0” correspond to arguments. A statement “printf(“%d”,*x);” corresponds to a code directly entered to complement a capability that lacks among the preliminarily prepared functions.

The address of the function is entered in the function pointer of an execution code. Thus, for example, in the function pointers “(*fp[?])” and “{?}” of the template shown in FIG. 6B, a numeral “5” obtained by adding one to the number of functions shown in FIG. 7B, and “0, &F1, &F2, &F3, &F4” are entered, respectively, thereby generating a new program described according to a code shown in FIG. 7C.

The setting files 25 and 35 are generated by the verification setting automatic creation process of the application software 1, and are stored in the vehicle test apparatus 10 and the simulated verification device 30, respectively. The setting file 25 contains test software that is an operation target, time-out period setting, a determination value of the test software and the like. The setting file 35 contains ECU that is a test target, a command to be used, a response to the command (a value measured by a simulation sensor) and the like.

To confirm whether the generated new test software 222 has specifications in conformity with planned specifications or not, a communication verification of all the routes in the flowchart that represents a series of processes executed by the test software 222 is executed. In this verification, the vehicle test apparatus 10 is connected not to the vehicle 42 but to the simulated verification device 30 as what simulates a vehicle. According to the operator's selection of the routes in the flowchart, the diagram of the route and the color of the arrow are changed, and setting is automatically calculated so as to pass through the route.

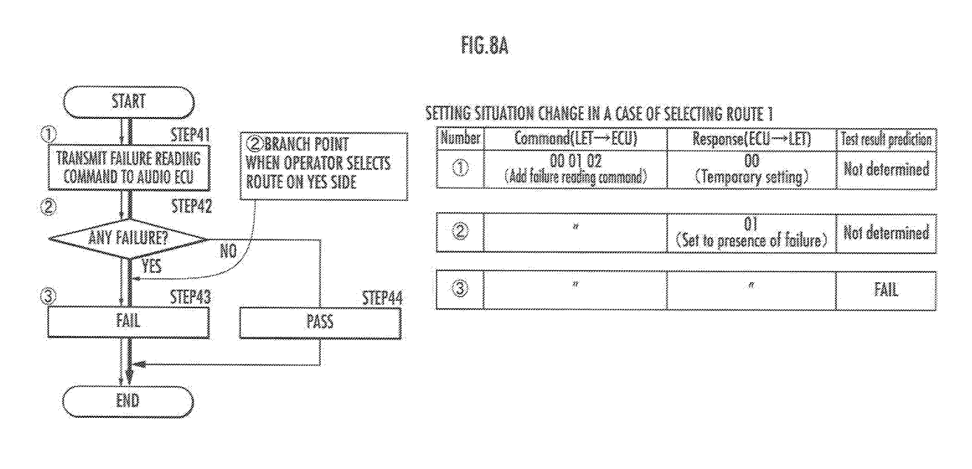

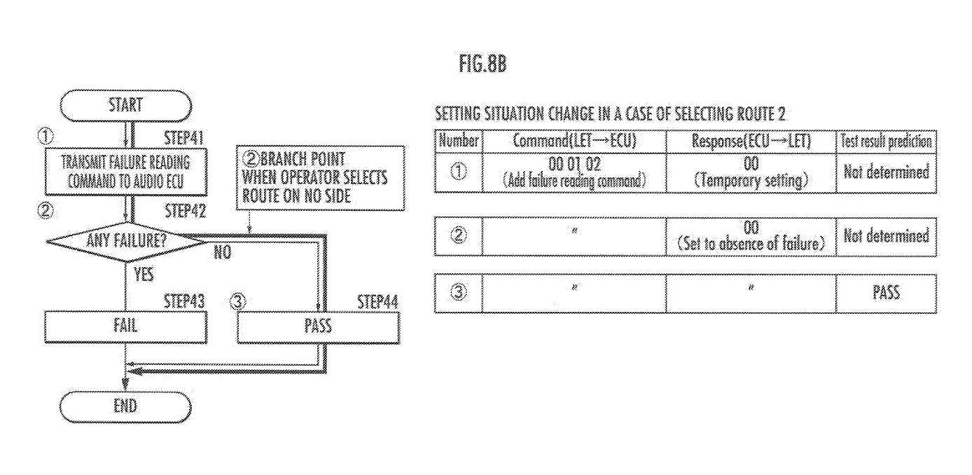

The flowchart is displayed on the display of PC. Thus, for example, the flowcharts shown on the left side of FIG. 8A and the left side of FIG. 8B are displayed on the display. An operation on a keyboard, a mouse or the like of the PC selects the route of the flowchart. Thus, for example, as shown on the left side of FIG. 8A, a route sequentially passing through a process STEP 41, branch STEP 42 and process STEP 43 is selected. Alternatively, as shown on the left side of FIG. 8B, a route sequentially passing through the process STEP 41, branch STEP 42 and process STEP 44 is selected. According to the selection of the route on the left side of FIG. 7A, a result of simulation of situations transitioning as shown in the tables on the right side of FIG. 7A is displayed. The setting file 25 and the setting file 35 for allowing the vehicle test apparatus 10 and the simulated verification device 30 to operate according to the selected route are automatically generated. The setting file 25 is input into the vehicle test apparatus 10, and the setting file 35 is input into the simulated verification device 30, and operations are performed, thereby allowing the user to confirm whether or not the generation has been performed in conformity with the specifications that the test software intends.

(Effects)

The method for supporting program creation of the present invention removes unnecessary factors from codes contained in the information software 21, and basic codes are created (see FIGS. 4A and 4B). Consequently, situations where unnecessary factors inhibit application of a predetermined extraction rule are prevented, and the pieces of designation information pertaining to the respective capabilities are securely extracted from the basic codes according to the predetermined extraction rule. As the existing program can be compiled, the designation information pertaining to a meaningless code that cannot be executed is prevented from being extracted.

The extracted designation information can be used to allow the user to select indirectly or directly the capability or processing details contained in the new test software 222 scheduled to be generated (see FIG. 5). That is, selection of the capability through selection of the symbol and selection of the designation information enables the user to create the flowchart made up of components defined by the selected symbol and the selected capability. Consequently, the user's erroneous input and erroneous description during flowchart creation are securely avoided, thereby facilitating improvement in flowchart creation accuracy.

The functions (see the right side of FIG. 7A) associated with the respective components included in the created flowchart (see the left side of FIG. 7A) are entered in the template (predetermined pattern (see FIG. 6B)), thereby automatically generating the new code describing the new test software 222 (see FIG. 7C).

Accordingly, even if the user's program creation skill is not much high, a program having high quality in conformity with the specifications is generated only with knowledge of the program specifications to a certain extent. Consequently, reduction in the cost of creating the program is facilitated.

What is claimed is:

1. A method for supporting program creation, comprising:
a first process of removing unnecessary factors from a plurality of codes that describe a plurality of capabilities included in a compilable existing program to create a plurality of basic codes, and extracting a plurality of designation information associated with the respective capabilities from among each of the basic codes according to a predetermined extraction rule;
a second process of selecting at least one symbol among a plurality of symbols and selecting at least one designation information from among the plurality of designation information to create a new flowchart that includes at least two components among a plurality of components that are defined by the symbols and capabilities and are associated with respective functions, the at least two components being defined by the selected symbol and the capability associated with the selected designation information; and
a third process of entering, in a predetermined pattern, at least two functions associated with the at least two components among the functions to generate a new code describing a new program.

2. The method for supporting program creation according to claim 1,
wherein the new program is at least a part of software for diagnosing a vehicle used in a vehicle test apparatus for diagnosing various capabilities of the vehicle.

3. The method for supporting program creation according to claim 1,
wherein the second process comprises:
a step of causing an output interface to display the plurality of symbols according to capability types containing at least one of a process, defined process, preparation, determination, manual operation input, internal storage, stored data, terminal, and combinator; and
a step of selecting the at least one symbol through an input interface.

4. The method for supporting program creation according to claim 1,
wherein the second process comprises:
a step of causing an output interface to display input fields for allowing first classification, second classification, and the designation information to be sequentially selected; and
a step of selecting the first classification, selecting the second classification contained in the selected first classification, and selecting the at least one designation information contained in the selected second classification, through an input interface.

5. The method for supporting program creation according to claim 1,
wherein the third process comprises:
a step of assigning numbers to the at least two components that constitute the flowchart;
a step of determining a function name, based on the respective symbols and capabilities of the at least two components;
a step of extracting an argument according to the function name;
a step of generating the function of the number based on the number assigned with the function name and the argument; and
a step of entering an address of the function in a function pointer of an execution code to generate the new code.

6. The method for supporting program creation according to claim 1,
wherein the predetermined pattern includes a code directly entered to complement a capability that lacks among a preliminarily prepared function group.

7. An apparatus for supporting program creation, comprising
a processor
wherein the processor, comprises:
a first process element of removing unnecessary factors from a plurality of codes that describe a plurality of capabilities included in a compilable existing program to create a plurality of basic codes, and extracting a plurality of designation information associated with the respective capabilities from among each of the basic codes according to a predetermined extraction rule;
a second process element of selecting at least one symbol among a plurality of symbols and selecting at least one designation information from among the plurality of designation information to create a new flowchart that includes at least two components among a plurality of components that are defined by the symbols and capabilities and are associated with respective functions, the at least two components being defined by the selected symbol and the capability associated with the selected designation information; and
a third process element of entering, in a predetermined pattern, at least two functions associated with the at least two components among the functions to generate a new code describing a new program.

8. The apparatus for supporting program creation according to claim 7,
wherein the new program is at least a part of software for diagnosing a vehicle used in a vehicle test apparatus for diagnosing various capabilities of the vehicle.

9. The apparatus for supporting program creation according to claim 7,
wherein the second process element comprises a capability element that executes:
a step of causing an output interface to display the plurality of symbols according to capability types containing at least one of a process, defined process, preparation, determination, manual operation input, internal storage, stored data, terminal, and combinator; and
a step of selecting the at least one symbol through an input interface.

10. The apparatus for supporting program creation according to claim 7,
wherein the second process element comprises a capability element that executes:
a step of causing an output interface to display input fields for allowing first classification, second classification, and the designation information to be sequentially selected; and
a step of selecting the first classification, selecting the second classification contained in the selected first classification, and selecting the at least one designation information contained in the selected second classification, through an input interface.

11. The apparatus for supporting program creation according to claim 7,
wherein the third process element comprises a capability element that executes:
a step of assigning numbers to the at least two components that constitute the flowchart;
a step of determining a function name, based on the respective symbols and capabilities of the at least two components;
a step of extracting an argument according to the function name;
a step of generating the function of the number based on the number assigned with the function name and the argument; and
a step of entering an address of the function in a function pointer of an execution code to generate the new code.

12. The apparatus for supporting program creation according to claim 7,
wherein the predetermined pattern includes a code directly entered to complement a capability that lacks among a preliminarily prepared function group.
